(19) United States
(12) Patent Application Publication
(10) Pub. No.: US 2024/0009781 A1
(43) Pub. Date: Jan. 11, 2024

(54) INDUSTRIAL MACHINE PROVIDED WITH PAIR OF POSITIONERS FOR HOLDING WORKPIECE

(71) Applicant: Fanuc Corporation, Minamitsuru-gun, Yamanashi (JP)

(72) Inventor: Ryouji Kitamura, Minamitsuru-gun, Yamanashi (JP)

(73) Assignee: Fanuc Corporation, Minamitsuru-gun, Yamanashi (JP)

(21) Appl. No.: 18/034,931

(22) PCT Filed: Nov. 2, 2021
(86) PCT No.: PCT/JP2021/040422

§ 371 Date: May 2, 2023

(30) Foreign Application Priority Data
Nov. 9, 2020 (JP) 2020-186645

(51) Int. Cl. B23K 37/047; B23K 37/04

(52) U.S. Cl. CPC B23K 37/047; B23K 37/0435

(57) ABSTRACT

An industrial machine is provided with: a work stand on which a first workpiece is placed; a pair of positioners for holding the first workpiece that has been placed on the work stand, wherein one positioner of the pair of positioners is provided so as to be able to move toward and away from the other positioner; and slide mechanisms for supporting the work stand such that the one positioner is able to slide in a direction approaching the other positioner.

### CROSS REFERENCE TO RELATED APPLICATIONS

This is the U.S. National Phase application of PCT/JP2021/040422, filed Nov. 2, 2021, which claims priority to Japanese Patent Application No. 2020-186645, filed Nov. 9, 2020, the disclosures of each of these applications being incorporated herein by reference in their entireties for all purposes.

### FIELD OF THE INVENTION

The present invention relates to an industrial machine provided with a pair of positioners that clamp a workpiece.

### BACKGROUND OF THE INVENTION

An industrial machine provided with a pair of positioners that clamp a workpiece is widely known (e.g., PTL 1).

### PATENT LITERATURE

PTL 1: JP 2011-167703 A

### SUMMARY OF THE INVENTION

It has been desired to improve work quality by appropriately clamping a workpiece by a pair of positioners.

In one aspect of the present disclosure, an industrial machine includes a workpiece platform on which a first workpiece is placed, a pair of positioners that clamp the first workpiece placed on the workpiece platform, in which one of the pair of positioners is movable toward and away from the other of the pair of positioners, and a slide mechanism that supports the workpiece platform slidably in an approaching direction in which the one of the pair of positioners approaches the other of the pair of positioners.

According to the present disclosure, action of the slide mechanism makes it possible to hinder an excessive force from being applied to the first workpiece when the first workpiece is clamped by the pair of positioners, to hinder the first workpiece from being inclined on the workpiece platform, and to hinder the first workpiece from being deformed. As a result, the pair of positioners can appropriately clamp the first workpiece, thereby making it possible to improve work quality with respect to the first workpiece.

### BRIEF DESCRIPTION OF DRAWINGS

FIG. 1 is a block diagram of an industrial machine according to one embodiment.

FIG. 2 is a front view of the industrial machine illustrated in FIG. 1.

FIG. 3 is a top view of the industrial machine illustrated in FIG. 1.

FIG. 4 is a cross-sectional view taken along a line IV-IV in FIG. 3.

FIG. 5 is a diagram illustrating only a workpiece support mechanism of the industrial machine illustrated in FIG. 3.

FIG. 6 is an enlarged view of a workpiece platform illustrated in FIG. 5.

FIG. 7 is a diagram of the workpiece platform illustrated in FIG. 6 when viewed from the rear.

FIG. 8 is a cross-sectional view taken along a line VIII-VIII in FIG. 6.

FIG. 9 is a diagram illustrating a state in which the workpiece platform is slid and corresponds to FIG. 7.

FIG. 10 is a diagram illustrating a state in which the workpiece platform is slid and corresponds to FIG. 8.

FIG. 11 is an exploded perspective view of a workpiece according to one embodiment.

FIG. 12 is a flowchart illustrating an example of an operation flow of the industrial machine illustrated in FIG. 1.

FIG. 13 is a flowchart illustrating an example of an operation flow of step S4 in FIG. 12.

FIG. 14 is a flowchart illustrating another example of the operation flow of step S4 in FIG. 12.

FIG. 15 is a flowchart illustrating still another example of the operation flow of step S4 in FIG. 12.

FIG. 16 illustrates a workpiece support mechanism according to another embodiment.

FIG. 17 is a cross-sectional view taken along a line XVII-XVII in FIG. 6.

FIG. 18 illustrates a state in which a workpiece platform illustrated in FIG. 16 is slid to a slide position.

### DETAILED DESCRIPTION OF EMBODIMENTS OF THE INVENTION

Hereinafter, embodiments of the present disclosure are described in detail with reference to the drawings. In various embodiments described below, the same elements are denoted by the same reference signs, and redundant description will be omitted. In the following description, an orthogonal coordinate system C in each drawing is used as a reference for directions, and for the sake of convenience, a positive x-axis direction is referred to as a rightward direction, a positive y-axis direction is referred to as a frontward direction, and a positive z-axis direction is referred to as an upward direction. A z-axis of the coordinate system C is parallel to a vertical axis, for example.

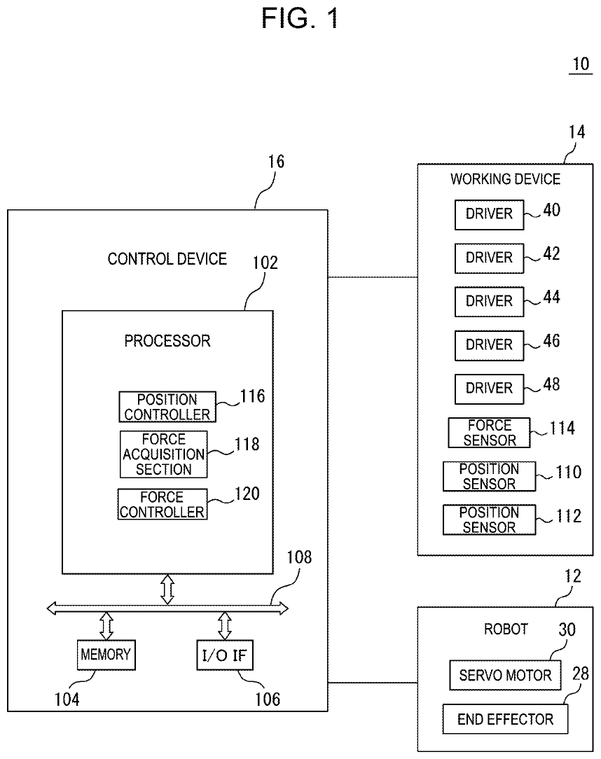

First, an industrial machine 10 according to one embodiment will be described with reference to FIG. 1 to FIG. 10. In the present embodiment, the industrial machine 10 is a welding machine that welds workpieces W1, W2, and W3 described below. The industrial machine 10 includes a robot 12, a working device 14, and a control device 16.

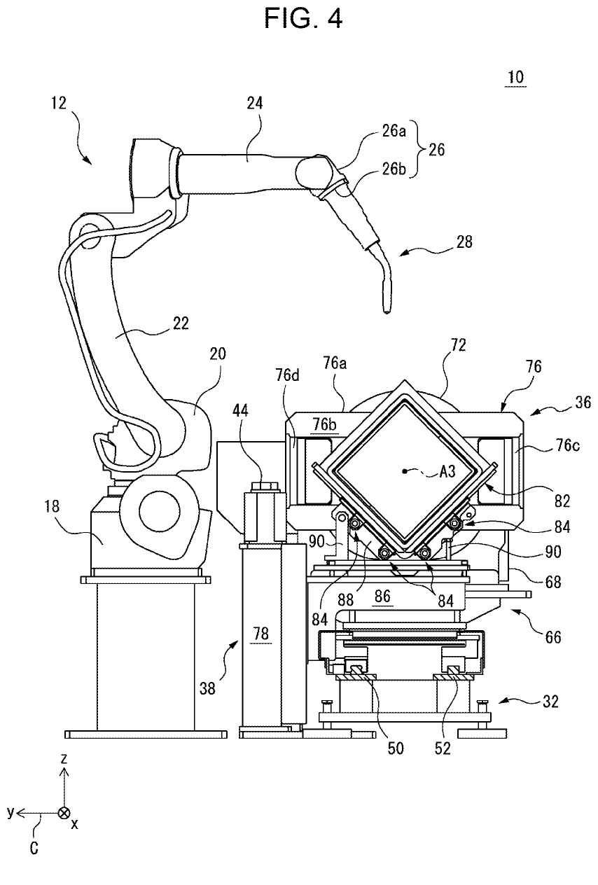

As illustrated in FIG. 4, in the present embodiment, the robot 12 is a vertical articulated robot and includes a robot base 18, a turning torso 20, a lower arm 22, an upper arm 24, a wrist 26, and an end effector 28. The robot base 18 is fixed on the floor of a work cell.

The turning torso 20 is provided on the robot base 18 so as to be able to turn about an axis parallel to the z-axis of the coordinate system C. A base end of the lower arm 22 is pivotally provided on the turning torso 20. A base end of the upper arm 24 is provided on a tip of the lower arm 22 to be pivotally movable about two axes orthogonal to each other.

The wrist 26 includes a wrist base 26a pivotally provided on a tip of the upper arm 24, and a wrist flange 26b pivotally provided on the wrist base 26a. The end effector 28 is removably attached to the wrist flange 26b. In the present embodiment, the end effector 28 is a welding torch and performs welding operation on a workpiece in response to a command from the control device 16. A servo motor 30 (FIG. 1) is provided in each of the constituent elements (the robot base 18, the turning torso 20, the lower arm 22, the upper arm 24, and the wrist 26) of the robot 12. These servo motors 30 pivot the corresponding movable elements (the turning torso 20, the lower arm 22, the upper arm 24, the wrist 26, and the wrist flange 26b) of the robot 12 about respective drive shafts in response to commands from the control device 16. As a result, the robot 12 can move and arrange the end effector 28 at any position of the coordinate system C and in any orientation.

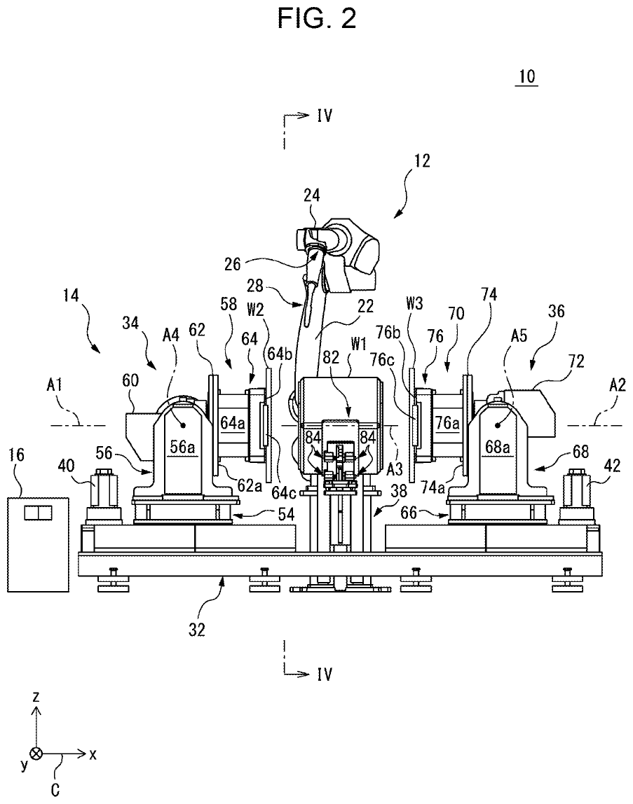

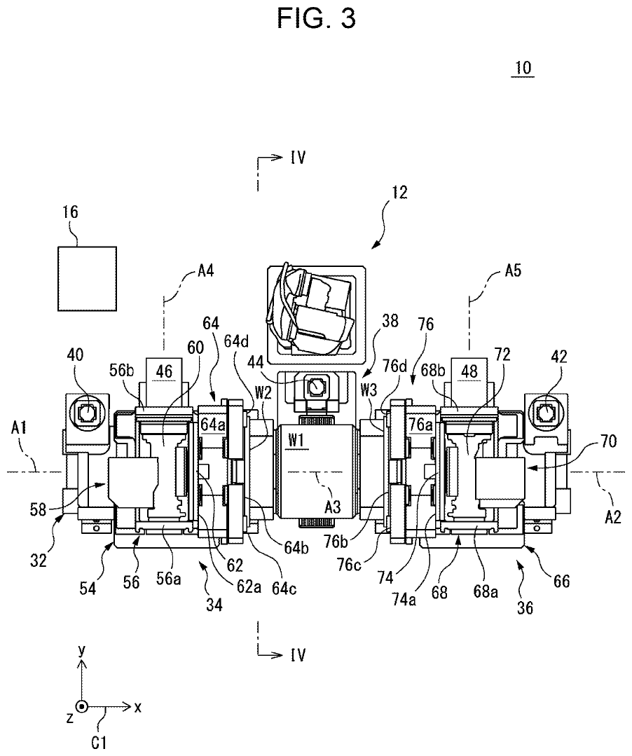

The working device 14 is a device that clamps the workpieces W1, W2, and W3 for welding operation by the robot 12. Specifically, as illustrated in FIG. 2 and FIG. 3, the working device 14 includes a base portion 32, a pair of positioners 34 and 36, a workpiece support mechanism 38, and drivers 40, 42, 44, 46, and 48. The base portion 32 is fixed on the floor of the work cell and includes a pair of rails 50 and 52 (FIG. 4) extending in an x-axis direction of the coordinate system C.

The positioner 34 is provided on the base portion 32 so as to be slidable in the x-axis direction of the coordinate system C1. Specifically, the positioner 34 includes a slider 54, a pedestal 56, and a chuck mechanism 58. The slider 54 is slidably engaged with the rails 50 and 52 at its lower end. The pedestal 56 is fixed to the slider 54 so as to extend upward from the slider 54 and includes a pair of support walls 56a and 56b arranged opposing each other in a y-axis direction of the coordinate system C.

The chuck mechanism 58 is supported by the pedestal 56 so as to be pivotally movable about an axis A4 parallel to the y-axis direction of the coordinate system C. Specifically, the chuck mechanism 58 includes a base 60, a rotary table 62, a first rotary table driver (not illustrated), and a chuck 64. The base 60 is hollow and pivotally supported about the axis A4 between the support walls 56a and 56b.

The rotary table 62 is a disk-shaped member having a center axis A1 and is provided on the base 60 so as to be rotatable about the axis A1. The first rotary table driver is, for example, a servo motor, is accommodated inside the base 60, and rotates the rotary table 62 about the axis A1 in response to a command from the control device 16.

The chuck 64 is fixed to a tip surface 62a of the rotary table 62. Specifically, the chuck 64 includes a chuck main body 64a having a substantially rectangular outer shape, a plurality of chuck claws 64c and 64d provided on a tip surface 64b of the chuck main body 64a in an openable and closable manner, and a first chuck claw driver (not illustrated) built in the chuck main body 64a.

The first chuck claw driver is, for example, a pneumatic or hydraulic cylinder, or a servo motor and causes the chuck claws 64c and 64d to open and close in response to a command from the control device 16. The chuck 64 can grasp and release the workpiece W2 described below by the chuck claws 64c and 64d that are opened and closed.

The driver 40 (first driver) is fixed to the left end portion of the base portion 32. In the present embodiment, the driver 40 is a servo motor and causes the positioner 34 to reciprocate in the x-axis direction of the coordinate system C in response to a command from the control device 16.

Specifically, the base portion 32 is provided with a first motion conversion mechanism (e.g., a ball screw mechanism) that converts a rotational motion of a rotary shaft (not illustrated) of the driver 40 into a reciprocating motion in the x-axis direction of the coordinate system C. The driver 40 rotates the rotary shaft thereof to reciprocate the positioner 34 in the x-axis direction of the coordinate system C via the first motion conversion mechanism.

As illustrated in FIG. 3, the driver 46 is fixed to the outer surface of the support wall 56b of the pedestal 56. In the present embodiment, the driver 46 is, for example, a servo motor and pivots the chuck mechanism 58 (and the axis A1) about the axis A4 in response to a command from the control device 16.

The positioner 36 is arranged at the right side of the positioner 34 while opposing the positioner 34 and is provided on the base portion 32 so as to be slidable along the x-axis of the coordinate system C1. The positioner 36 has a configuration similar to that of the positioner 34. Specifically, the positioner 36 includes a slider 66, a pedestal 68, and a chuck mechanism 70.

The slider 66, the pedestal 68, and the chuck mechanism 70 are arranged symmetrical with the slider 54, the pedestal 56, and the chuck mechanism 58 of the positioner 34, respectively, with reference to a plane parallel to a y-z plane of the coordinate system C and arranged between the positioners 34 and 36. The slider 66 is slidably engaged with the rails 50 and 52 at its lower end. The pedestal 68 is fixed to the slider 66 and includes a pair of support walls 68a and 68b arranged opposing each other in the y-axis direction of the coordinate system C.

The chuck mechanism 70 is supported by the pedestal 68 so as to be pivotally movable about an axis A5 parallel to the y-axis direction of the coordinate system C and includes a base 72, a rotary table 74, a second rotary table driver (not illustrated), and a chuck 76. The base 72 is hollow and pivotally supported about the axis A5 between the support walls 68a and 68b.

The rotary table 74 is a disk-shaped member having a center axis A2 and is provided on the base 72 so as to be rotatable about the axis A2. The second rotary table driver is, for example, a servo motor, is accommodated inside the base 72, and rotates the rotary table 74 about the axis A2 in response to a command from the control device 16.

The chuck 76 is fixed to a tip surface 74a of the rotary table 74 and includes a chuck main body 76a having a substantially rectangular outer shape, a plurality of chuck claws 76c and 76d provided on a tip surface 76b of the chuck main body 76a in an openable and closable manner, and a second chuck claw driver (not illustrated) built in the chuck main body 76a.

The second chuck claw driver is, for example, a cylinder or servo motor and causes the chuck claws 76c and 76d to open and close in response to a command from the control device 16. The chuck 76 can grasp and release the workpiece W3 described below by the chuck claws 76c and 76d that are opened and closed.

The driver 42 (second driver) is fixed to the right end portion of the base portion 32. In the present embodiment, the driver 42 is a servo motor and causes the positioner 36 to reciprocate in the x-axis direction of the coordinate system C in response to a command from the control device 16. Specifically, the base portion 32 is provided with a second motion conversion mechanism (e.g., a ball screw mechanism) that converts a rotational motion of a rotary shaft (not illustrated) of the driver 42 into a reciprocating motion in the x-axis direction of the coordinate system C. The driver 42 rotates the rotary shaft thereof to make it possible to reciprocate the positioner 36 in the x-axis direction of the coordinate system C via the second motion conversion mechanism.

As illustrated in FIG. 3, the driver 48 is fixed to the outer surface of the support wall 68b of the pedestal 68. In the present embodiment, the driver 48 is, for example, a servo motor and pivots the chuck mechanism 70 (and the axis A2) about the axis A5 in response to a command from the control device 16.

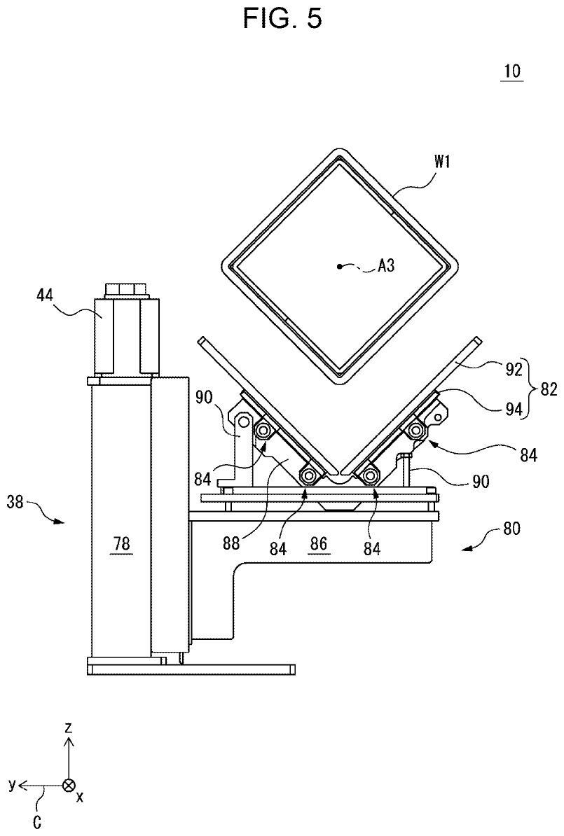

Referring to FIG. 4 and FIG. 5, the workpiece support mechanism 38 includes a support column 78, an elevator 80, a workpiece platform 82, and a slide mechanism 84. The support column 78 is a hollow member extending in a z-axis direction of the coordinate system C and is fixed on the floor of the work cell. The elevator 80 is provided at a rear portion of the support column 78 so as to be movable in the z-axis direction of the coordinate system C. Specifically, the elevator 80 includes a support table 86 having a substantially L shape when viewed from the left, a support beam 88 fixed on the support table 86 and having a substantially V-shaped outer shape when viewed from the left, and a fixture 90 for fixing the support table 86 and the support beam 88 to each other.

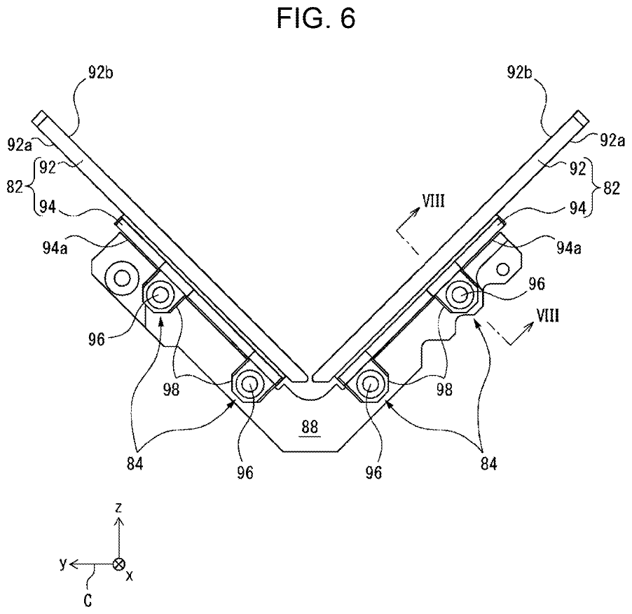

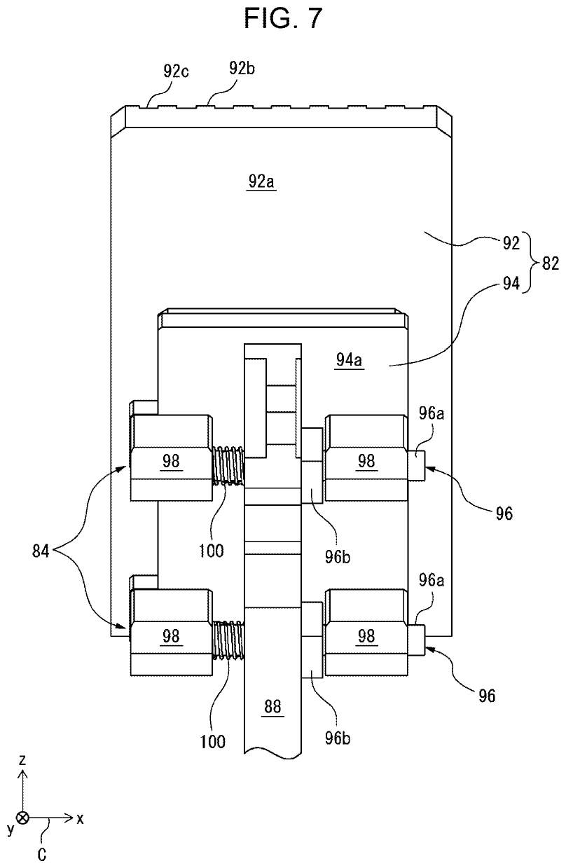

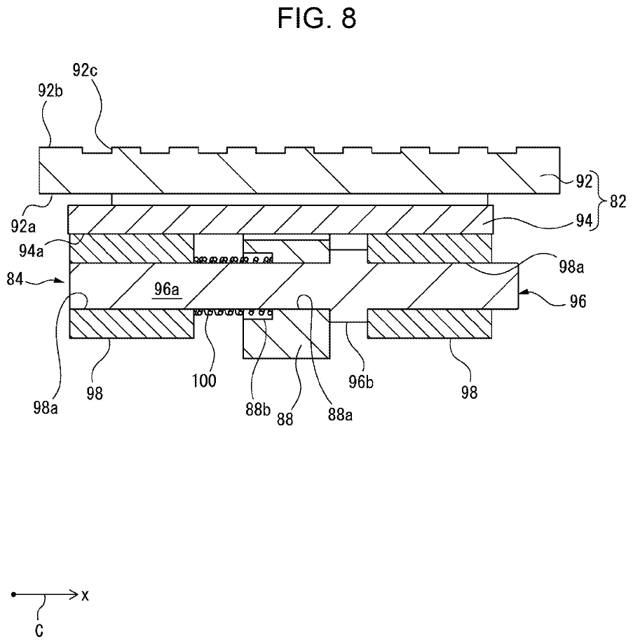

As illustrated in FIG. 6, the workpiece platform 82 is a member having a substantially V shape when viewed from the left and is arranged above the elevator 80. Specifically, the workpiece platform 82 includes a main plate 92 and an auxiliary plate 94 fixed to a rear surface 92a of the main plate 92. The main plate 92 has a front surface 92b on which the workpiece W1 is placed from above, and an uneven portion 92c is formed on the front surface 92b (FIG. 7 and FIG. 8). The uneven portion 92c makes it possible to increase a friction coefficient between the workpiece W1 placed on the front surface 92b and the front surface 92b. Instead of the uneven portion 92c, the front surface 92b may be provided with a rubber material or a resin material that can increase the friction coefficient with respect to the workpiece W1.

In the present embodiment, the slide mechanism 84 supports the workpiece platform 82 on the elevator 80 (specifically, the support beam 88) so as to be slidable in the right direction. In the present embodiment, a total of four slide mechanisms 84 are interposed between the support beam 88 of the elevator 80 and the auxiliary plate 94 of the workpiece platform 82.

Hereinafter, the slide mechanism 84 will be described with reference to FIG. 6 to FIG. 8. Each of the slide mechanisms 84 includes a shaft 96, a pair of bushings 98, and a biasing portion 100. The shaft 96 is a column-shaped member arranged so as to extend in the x-axis direction of the coordinate system C. Specifically, the shaft 96 includes a main body 96a and a flange 96b projecting outward from the main body 96a, as illustrated in FIG. 8. The main body 96a is inserted into a through hole 88a formed in the support beam 88 and is fixed relative to the support beam 88. The flange 96b abuts against the right end face of the support beams 88.

The pair of bushings 98 is separated from each other in the x-axis direction of the coordinate system C, and the support beam 88 and the flange 96b are arranged between the pair of bushings 98. Each of the pair of bushings 98 is a cylindrical member having a through hole 98a extending in the x-axis direction of the coordinate system C and is integrally fixed to a rear surface 94a of the auxiliary plate 94. The through hole 98a receives the main body 96a of the shaft 96 in a slidable manner.

The biasing portion 100 is a stretchable elastic member such as a coil spring and is interposed between the support beam 88 and the bushing 98 located on the left side of the support beam 88. The main body 96a of the shaft 96 is inserted into the biasing portion 100. A diameter-expanded hole 88b obtained by expanding the diameter of the through hole 88a is formed at the left end portion of the through hole 88a formed in the support beam 88, and the right end portion of the biasing portion 100 is accommodated in the diameter-expanded hole 88b.

FIG. 7 and FIG. 8 each illustrate a state in which the workpiece platform 82 is arranged at an initial position. When the workpiece platform 82 is arranged at the initial position, the left end face of the bushing 98 located on the right side of the support beam 88 abuts against the right end face of the flange 96b, thereby restricting leftward sliding of the workpiece platform 82 from the initial position.

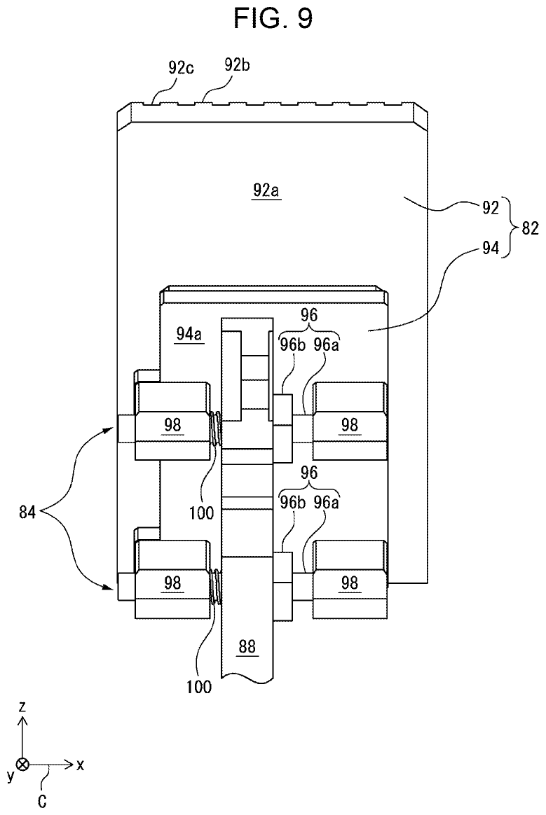

On the other hand, when the workpiece platform 82 arranged at the initial position is pushed rightward, the workpiece platform 82 is slid rightward by the slide mechanism 84. FIG. 9 and FIG. each illustrate a state in which the workpiece platform 82 has been slid rightward from the initial position. At this time, the biasing portion 100 is pressed in the x-axis direction of the coordinate system C and biases the left-side bushing 98 leftward as a reaction force with respect to being pressed, whereby the workpiece platform 82 is biased leftward by the biasing portion 100.

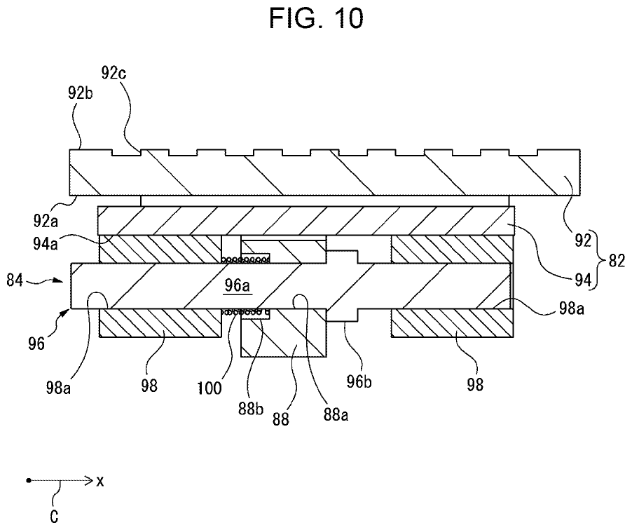

When the force pushing the workpiece platform 82 rightward is released from the state illustrated in FIG. 9 and FIG. 10, the workpiece platform 82 slides leftward by the slide mechanism 84 due to the action of the biasing portion 100 and stops at the initial position illustrated in FIG. 7 and FIG. 8 by the engagement of the right-side bushing 98 with the flange 96b.

As described above, in the present embodiment, the slide mechanism 84 allows the workpiece platform 82 to slide rightward from the initial position, while restricts the workpiece platform 82 from sliding leftward from the initial position. Because the slide mechanism 84 is configured to allow the workpiece platform 82 to slide in only one direction as described above, the dimension of the slide mechanism 84 in the x-axis direction of the coordinate system C can be made compact, and thus space-saving may be achieved.

Referring again to FIG. 5, the driver 44 is fixed to the upper end face of the support column 78. The driver 44 is, for example, a servo motor and causes the elevator 80 to reciprocate in the z-axis direction of the coordinate system C in response to a command from the control device 16. Specifically, inside the support column 78, there is provided a third motion conversion mechanism (e.g., a ball screw mechanism) that converts a rotational motion of a rotary shaft (not illustrated) of the driver 44 into a reciprocating motion in the z-axis direction of the coordinate system C. The driver 44 rotates the rotary shaft thereof to reciprocate the elevator 80 in the z-axis direction of the coordinate system C via the third motion conversion mechanism.

Referring to FIG. 1, the control device 16 controls the operations of the robot 12 and the working device 14. Specifically, the control device 16 is a computer including a processor 102, a memory 104, and an I/O interface 106. The processor 102 is communicably connected to the memory 104 and the I/O interface 106 via a bus 108 and performs arithmetic processing for welding operation described below while communicating with these components.

The memory 104 includes a RAM, a ROM, or the like, and stores various types of data temporarily or permanently. The I/O interface 106 includes, for example, an Ethernet (trade name) port, a USB port, an optical fiber connector or an HDMI (trade name) terminal, and exchanges data with external devices (the end effector 28, servo motor 30, drivers 40, 42, 44, 46 and 48, and the like) through wired or wireless communication under commands from the processor 102.

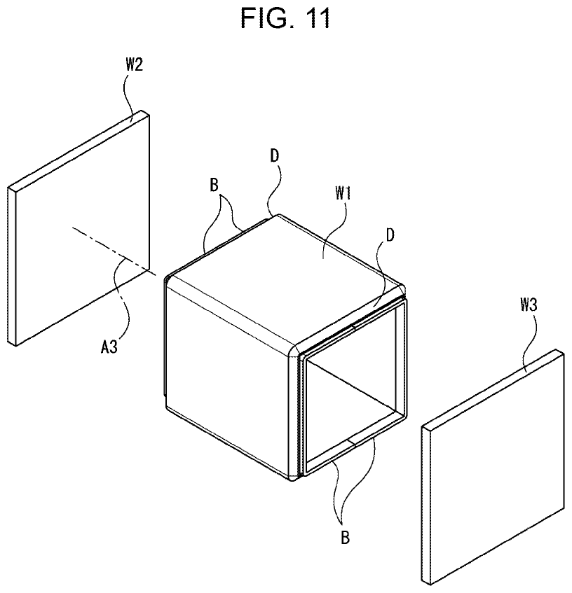

Next, the workpieces to be processed will be described with reference to FIG. 11. In the present embodiment, the control device 16 controls the robot 12 and the working device 14 to perform the operation of welding the three workpieces W1, W2, and W3 to each other. The workpiece W1 (first workpiece) is a substantially rectangular-shaped tubular member having a center axis A3, and backing members B are welded in advance to opening ends on both sides of the workpiece W1 in such a manner as to project outward from the opening ends.

Tapered portions D are formed at the opening ends on both sides of the workpiece W1. The workpiece W1 is, for example, a column core used for a column of a steel structure. On the other hand, the workpiece W2 (second workpiece) and the workpiece W3 (third workpiece) are flat plate members having the same shape, which is a substantially rectangular shape (e.g., a diaphragm used for a column of a steel structure).

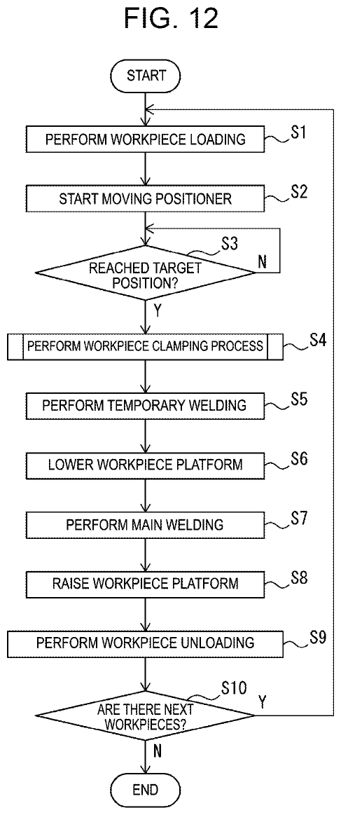

Next, an operation of the industrial machine 10 will be described with reference to FIG. 12. A flowchart illustrated in FIG. 12 is started when the processor 102 of the control device 16 receives an operation start command from an operator, a host controller, or an operation program. At the start of the flowchart illustrated in FIG. 12, the chuck mechanism 58 of the positioner 34 is arranged at a position pivoted about the axis A4 from the position illustrated in FIG. 2 by approximately 90 degrees in the counterclockwise direction when viewed from the rear.

In other words, at this time, the axis A1 of the chuck mechanism 58 is substantially parallel to the z-axis direction of the coordinate system C, and the tip surface 64b of the chuck main body 64a faces upward. The chuck claws 64c and 64d are maintained in the opened state. The positioner 34 is arranged at a predetermined initial position P_{1_0}. The initial position P_{1_0} may be set to the left end of a movement stroke of the positioner 34.

Similarly, at the start of the flowchart illustrated in FIG. 12, the chuck mechanism 70 of the positioner 36 is arranged in such a manner that the axis A2 thereof is substantially parallel to the z-axis direction of the coordinate system C and the tip surface 76b of the chuck main body 76a faces upward. The chuck claws 76c and 76d are maintained in the opened state. The positioner 36 is arranged at a predetermined initial position P_{2_0}. The initial position P_{2_0} may be set to the right end of a movement stroke of the positioner 36. The elevator 80 (i.e., the workpiece platform 82) is arranged at a predetermined upper position P_{3_1}.

In step S1, the processor 102 performs workpiece loading. Specifically, the processor 102 operates a robot for workpiece loading (not illustrated) different from the robot 12 so that the workpiece W1 stored in a predetermined storage location is picked up by the robot for workpiece loading and is set on the workpiece platform 82.

As a result, as illustrated in FIG. 2 to FIG. 4, the workpiece W1 is placed on the workpiece platform 82, and the workpiece platform 82 supports the workpiece W1 from below. In the present embodiment, the workpiece W1 is not fixed to the workpiece platform 82 by using a jig or the like but is placed on the workpiece platform 82 in a relatively slidable manner. However, as described above, because the uneven portion 92c is formed on the front surface 92b of the workpiece platform 82, a position shifting of the workpiece W1 placed on the workpiece platform 82 is suppressed by the friction force between the workpiece W1 and the uneven portion 92c.

Subsequently, the processor 102 operates the robot for workpiece loading so that the workpiece W2 conveyed by a feeding conveyor is picked up by the robot for workpiece loading and is set on the tip surface 64b of the chuck mechanism 58 of the positioner 34. Then, the processor 102 operates the first chuck claw driver to close the chuck claws 64c and 64d and causes the chuck claws 64c and 64d to grasp the workpiece W2. In this way, the positioner 34 (specifically, the chuck 64) grasps the workpiece W2.

Likewise, the processor 102 operates the robot for workpiece loading so that the workpiece W3 conveyed by a feeding conveyor is picked up by the robot for workpiece loading and is set on the tip surface 76b of the chuck mechanism 70 of the positioner 36. Then, the processor 102 operates the second chuck claw driver to close the chuck claws 76c and 76d and causes the chuck claws 76c and 76d to grasp the workpiece W3. In this way, the positioner 36 (specifically, the chuck 76) grasps the workpiece W3.

Subsequently, the processor 102 operates the driver 46 (FIG. 3) to pivot the chuck mechanism 58 about the axis A4 by approximately 90 degrees in the clockwise direction when viewed from the rear and operates the driver 48 to pivot the chuck mechanism 70 about the axis A5 by approximately degrees in the counterclockwise direction when viewed from the rear.

As a result, the chuck mechanism 58 and the workpiece W1, and the chuck mechanism 70 and the workpiece W3 are arranged at the corresponding positions illustrated in FIG. 2. At this time, the axis A3 of the workpiece W1 placed on the workpiece platform 82 arranged at the upper position P_{3_1}, the axis A1 of the chuck mechanism 58, and the axis A2 of the chuck mechanism 70 are aligned on a single straight line parallel to the x-axis of the coordinate system C.

In step S2, the processor 102 starts moving the positioners 34 and 36. Specifically, the processor 102 generates a position command CP_{1_1} for positioning the positioner 34 at a target position P_{1_1} and controls the driver 40 in accordance with the position command CP_{1_1} (position control). Here, the working device 14 further includes a position sensor 110 (FIG. 1) for detecting the position of the positioner 34 (specifically, the position in the x-axis direction of the coordinate system C). The position sensor 110 includes, for example, a rotation detector (an encoder, a Hall element, or the like) that detects the rotation (e.g., a rotational position or a rotation angle) of the rotary shaft of the driver 40, or a linear scale that detects the position of the positioner 34 in the x-axis direction of the coordinate system C.

The processor 102 generates the position command CP_{1_1} based on position feedback FB_{P1} from the position sensor 110 and controls the driver 40 to move the positioner 34 from the initial position P_{1_0} to the target position P_{1_1} in a direction approaching the positioner 36 (i.e., in the rightward direction). The target position P_{1_1} is predetermined by the operator as a position at which the workpiece W2 grasped by the positioner 34 is located separate leftward from the left end (strictly speaking, the backing member B projecting from the left opening end) of the workpiece W1 placed on the workpiece platform 82.

Similarly, the processor 102 generates a position command CP_{2_1} for positioning the positioner 36 at a target position P_{2_1} and controls the driver 42 in accordance with the position command CP_{2_1} (position control). Thus, in the present embodiment, the processor 102 serves as a position controller 116 (FIG. 1) that controls the driver 42 to position the positioner 36 at the target position P_{2_1}.

Here, the working device 14 further includes a position sensor 112 (FIG. 1) for detecting the position of the positioner 36 (specifically, the position in the x-axis direction of the coordinate system C). The position sensor 112 includes, for example, a rotation detector (an encoder, a Hall element, or the like) that detects the rotation (e.g., a rotational position or a rotation angle) of the rotary shaft of the driver 42, or a linear scale that detects the position of the positioner 36 in the x-axis direction of the coordinate system C.

The processor 102 generates the position command CP_{2_1} based on position feedback FB_{P2} from the position sensor 112 and controls the driver 40 to move the positioner 36 from the initial position P_{2_0} to the target position P_{2_1} in a direction approaching the positioner 34 (i.e., in the leftward direction). The target position P_{2_1} is predetermined by the operator as a position at which the workpiece W3 grasped by the positioner 36 is located separate rightward from the right end (strictly speaking, the backing member B projecting from the right opening end) of the workpiece W1 placed on the workpiece platform 82.

In step S3, the processor 102 determines whether or not the positioners 34 and 36 have respectively reached the target positions P_{1_1} and P_{2_1}. Specifically, the processor 102 determines whether or not the positioner 34 has reached the target position P_{1_1} based on the position feedback FB_{P1} from the position sensor 110 and determines whether or not the positioner 36 has reached the target position P_{2_1} based on the position feedback FB_{P2} from the position sensor 112.

When the positioner 34 has reached the target position P_{1_1} and the positioner 36 has reached the target position P_{2_1}, the processor 102 determines to take YES and the process proceeds to step S4. On the other hand, when the positioner 34 has not reached the target position P_{1_1} yet or the positioner 36 has not reached the target position P_{2_1} yet, the processor 102 determines to take NO and iterates step S3.

When the processor 102 determines to take YES in step S3, the processor 102 stops the positioners 34 and 36. At this time, while the processor 102 ends the position control of the driver 40, the processor 102 may actively maintain the positioner 36 at the target position P_{2_1} by continuing the position control of the driver 42 based on the position feedback FB_{P2}.

When it is determined to take YES in step S3, the workpiece W2 grasped by the positioner 34 is separated leftward from the workpiece W1 (backing member B) by a distance x₁, while the workpiece W3 grasped by the positioner 36 is separated rightward from the workpiece W1 (backing member B) by a distance x₂. The above-described target position P_{1_1} and target position P_{2_1} may be set such that the distance x₁ is substantially equal to or greater than the distance x₂ (x₁≥x₂). The target position P_{2_1} may be set such that the distance x₂ is smaller than a maximum slide stroke xₛ of the slide mechanism 84 sliding the workpiece platform 82 (x₂<xₛ).

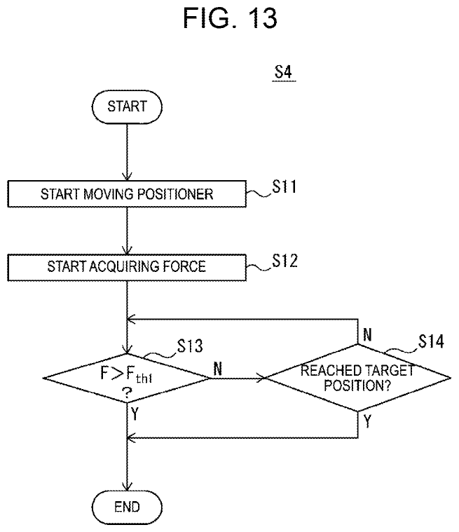

In step S4, the processor 102 performs processing of clamping the workpiece W1. Step S4 will be described below with reference to FIG. 13. In step S11, the processor 102 operates the driver 40 to move the positioner 34 further rightward from the target position P_{1_1}. Here, a speed V₁ at which the positioner 34 is moved in step S11 may be set to be lower than a speed V₂ at which the positioner 34 is moved in step S2 mentioned above (i.e., V₁<V₂).

When the positioner 34 is moved rightward, the workpiece W2 grasped by the positioner 34 abuts against the left end (backing member B) of the workpiece W1 placed on the workpiece platform 82 and pushes the workpiece W1 rightward. Here, the working device 14 further includes a force sensor 114 that detects force F with which the positioner 34 moved rightward by the driver 40 pushes the workpiece W1.

As an example, the force sensor 114 includes a torque sensor that detects a load torque F₁ applied to the rotary shaft of the driver 40 and transmits detected data DD of the load torque F₁ to the control device 16. As another example, the force sensor 114 includes a current sensor that acquires a feedback current F₂ of the driver 40 and transmits detected data DD of the feedback current F₂ to the control device 16. The feedback current F₂ corresponds to the load torque F₁.

As still another example, the force sensor 114 includes a strain gauge or the like provided in the chuck mechanism 58 (e.g., the chucks 64) or the workpiece W2 and that detects force F₃ applied from the workpiece W1 to the chuck mechanism 58 or the workpiece W2 and transmits detected data DD of the force F₃ to the control device 16.

In step S12, the processor 102 starts acquiring the force F. Specifically, the processor 102 continuously (e.g., periodically) acquires the detected data DD (the load torque F₁, feedback current F₂, or force F₃) detected by the force sensor 114 through the I/O interface 106.

As an example, the processor 102 acquires the detected data DD as data of the force F. As another example, the processor 102 may calculate and obtain the force F applied rightward from the positioner 34 (workpiece W2) to the workpiece W1 based on the detected data DD (e.g., the load torque F₁ or feedback current F₂) acquired from the force sensor 114. Thus, in the present embodiment, the processor 102 serves as a force acquisition section 118 (FIG. 1) that acquires the force F.

In step S13, the processor 102 determines whether or not the most recently acquired force F exceeds a predetermined threshold value Fₜₕ₁ (F>Fₜₕ₁). The threshold value Fag is determined in advance with respect to the force F and is stored in the memory 104. For example, when the processor 102 acquires the detected data DD of the load torque F₁ (or the feedback current F₂) as the force F, the threshold value Fₜₕ₁ can be set as a value between 15% and 20% of the rated value (or the maximum value) of the load torque F₁ (or the feedback current F₂).

If F>Fₜₕ₁, the processor 102 determines to take YES and stops the positioner 34. Then, the processor 102 ends step S4 and the process proceeds to step S5 in FIG. 12. On the other hand, if F≤Fₜₕ₁, the processor 102 determines to take NO, and the process proceeds to step S14.

In step S14, the processor 102 determines whether or not the positioner 34 has reached the target position P_{1_2} based on the position feedback FB_{P1}. The target position P_{1_2} is predetermined by the operator as a position which is separated rightward from the target position P_{1_1} of step S2 by a predetermined distance x₃ and at which the workpiece W2 grasped by the positioner 34 can clamp the workpiece W1 with the workpiece W3 grasped by the positioner 36 with the adequate force F.

When the positioner 34 has reached the target position P_{1_2}, the processor 102 determines to take YES and stops the positioner 34. Then, the processor 102 ends step S4 and the process proceeds to step S5 in FIG. 12. On the other hand, when the positioner 34 has not reached the target position P_{1_2} yet, the processor 102 determines to take NO and the process returns to step S13. In step S14, the processor 102 may determine whether or not the distance by which the positioner 34 is moved has reached the predetermined distance x₃ by using the start time of step S11.

Thus, in step S4, the processor 102 controls (force control) the driver 40 based on the force F acquired from the force sensor 114 to move the positioner 34 rightward. Then, the workpiece W2 grasped by the positioner 34 pushes the workpiece W1 placed on the workpiece platform 82 with the force F. In accordance with the force F, the workpiece platform 82 is slid rightward together with the workpiece W1 by the slide mechanism 84 (FIG. 9 and FIG. 10).

When step S4 is ended, the workpiece W1 is clamped between the workpiece W2 grasped by the positioner 34 and the workpiece W3 grasped by the positioner 36. Thus, in the present embodiment, the processor 102 serves as a force controller 120 (FIG. 1) that controls the operation of the driver 40 to cause the positioners 34 and 36 to clamp the workpiece W1 based on the force F.

Referring to FIG. 12 again, in step S5, the processor 102 performs temporary welding. Specifically, the processor 102 operates the robot 12 to perform spot-welding on a plurality of points at abutment of the workpiece W1 (backing member B) and the workpiece W2 by the end effector 28 and to perform spot-welding on a plurality of points at abutment of the workpiece W1 (backing member B) and the workpiece W3.

In step S6, the processor 102 lowers the workpiece platform 82. Specifically, the processor 102 operates the driver 44 to move the elevator 80 (i.e., the workpiece platform 82) downward from the upper position P_{3_1} to a predetermined lower position P_{3_2}. As a result, the workpiece platform 82 is separated downward from the workpiece W1 clamped by the positioners 34 and 36 and, at the same time, is slid leftward due to the action of the biasing portion 100 of the slide mechanism 84. Then, the workpiece platform 82 returns to the initial position illustrated in FIG. 7 and FIG. 8.

In step S7, the processor 102 performs main welding. Specifically, the processor 102 operates the second rotary table driver to rotate the rotary table 74 (i.e., the workpiece W3) in synchronization with operating the first rotary table driver to rotate the rotary table 62 (i.e., the workpiece W2). As a result, the workpieces W1, W2, and W3 are rotated about the axes A1 and A2.

In synchronization with the rotational operations of the rotary tables 62 and 74, the processor 102 operates the robot 12 to perform welding on the abutment of the workpiece W1 (backing member B) and the workpiece W2 across the whole circumference and to perform welding on the abutment of the workpiece W1 (backing member B) and the workpiece W3 across the whole circumference, by the end effector 28. The workpieces W1, W2, and W3 are thus welded to each other.

In step S8, the processor 102 raises the workpiece platform 82. Specifically, the processor 102 operates the driver 44 to move the elevator 80 (the workpiece platform 82) upward from the lower position P_{3_2} to the upper position P_{3_1}. As a result, the workpiece platform 82 abuts against the workpiece W1 clamped by the positioners 34 and 36 and supports the workpiece W1 again from below.

In step S9, the processor 102 performs workpiece unloading. Specifically, the processor 102 opens the chuck claws 64c and 64d of the chuck mechanism 58 and opens the chuck claws 76c and 76d of the chuck mechanism 70. Then, the processor 102 operates the driver 40 to move the positioner 34 leftward to return it to the initial position P_{1_0} and operates the driver 42 to move the positioner 36 rightward to return it to the initial position P_{2_0}.

Subsequently, the processor 102 operates the driver 46 (FIG. 3) to pivot the chuck mechanism 58 about the axis A4 by approximately 90 degrees in the counterclockwise direction when viewed from the rear and operates the driver 48 (FIG. 3) to pivot the chuck mechanism 70 about the axis A5 by approximately 90 degrees in the clockwise direction when viewed from the rear. Then, the processor 102 operates the robot for workpiece loading to pick up the assembly of the workpieces W1, W2, and W3 by the robot for workpiece loading and to convey the assembly to a predetermined storage location.

In step S10, the processor 102 determines whether or not there are workpieces W1, W2, and W3 to be welded next. For example, the processor 102 may determine whether or not there are workpieces W1, W2, and W3 to be welded next by analyzing the operation program. When the processor 102 determines to take YES, the process returns to step S1. On the other hand, when the processor 102 determines to take NO, the flowchart illustrated in FIG. 12 is ended.

As described above, in the present embodiment, the slide mechanism 84 supports the workpiece platform 82 slidably in a direction in which the positioner 34 approaches the positioner 36 (i.e., in the rightward direction). By the slide mechanism 84, when the positioner 34 moves rightward and the workpiece W1 placed on the workpiece platform 82 is clamped by the positioners 34 and 36 (specifically, the workpieces W2 and W2), the force F applied from the positioner 34 to the workpiece W1 may be absorbed by the slide operation.

This makes it possible to hinder an excessive force F from being applied to the workpiece W1, to hinder the workpiece W1 from being shifted or inclined on the workpiece platform 82, and to hinder deformation of the workpiece W1 (or the backing member B). As a result, because the positioners 34 and 36 can clamp the workpieces W1, W2, and W3 in such a manner that the workpiece W1 (backing member B) and the workpiece W2 as well as the workpiece W1 (backing member B) and the workpiece W3 are approximately abutted against each other without any gap therebetween, welding quality can be enhanced when the main welding is performed in step S7.

Even when there is an error in the set position of the workpiece W1 or the dimension of the workpiece W1 (or the dimension or welding position of the backing member B), the error can be canceled to some extent by the slide operation, and thus the positioners 34 and 36 can clamp the workpieces W1, W2, and W3 so that the workpiece W1 and the workpieces W2 and W3 abut against each other appropriately.

In the present embodiment, the slide mechanism 84 includes the biasing portion 100 that biases the workpiece platform 82 leftward when the workpiece platform 82 slides rightward. This configuration makes it possible to automatically return the workpiece platform 82 to the initial position in step S6 with a relatively simple structure.

In the present embodiment, the processor 102 serves as the force controller 120 and performs an operation of causing the positioners 34 and 36 to clamp the workpiece W1 by performing force control on the driver 40 based on the acquired force F so that the force F does not become excessive (step S4). This configuration makes it possible to more effectively manage and optimize the force F applied from the positioner 34 to the workpiece W1 in step S4 through the slide operation performed by the slide mechanism 84 and the force control. As a result, the welding quality can be more effectively improved.

In the present embodiment, the processor 102 serves as the position controller 116 and performs position control on the driver 42 in order to position the positioner 36 at the target position P_{2_1} before step S4 (step S2). When the positioner 36 is positioned at the target position P_{2_1}, the processor 102 serves as the force controller 120 and performs force control on the driver 40 to move the positioner 34 rightward (step S4).

According to this configuration, the workpieces W1, W2, and W3 clamped by the positioners 34 and 36 in step S4 can be positioned at the known position with reference to the target position P_{2_1} of the positioner 36. Accordingly, in steps S5 and S7, the end effector 28 of the robot 12 can be accurately positioned at the abutment of the workpiece W1 (backing member B) and the workpieces W2 and W3, so that the welding operation in steps S5 and S7 can be performed with high accuracy.

In the present embodiment, the target position P_{2_1} of the positioner 36 in step S2 is defined as a position at which the workpiece W3 grasped by the positioner 36 is separated from the workpiece W1. As the workpiece W1 is pushed by the workpiece W2 in step S4, the slide mechanism 84 slides the workpiece platform 82 rightward to make the workpiece W1 be clamped between the workpieces W2 and W3.

This configuration makes it possible to reliably slide the workpiece platform 82 rightward in step S4 and to hinder a situation in which the workpiece W3 grasped by the positioner 36 hits the workpiece W1 to apply an excessive force in step S2. Accordingly, a situation in which the workpiece W1 is inclined caused by the workpiece W3 may be hindered.

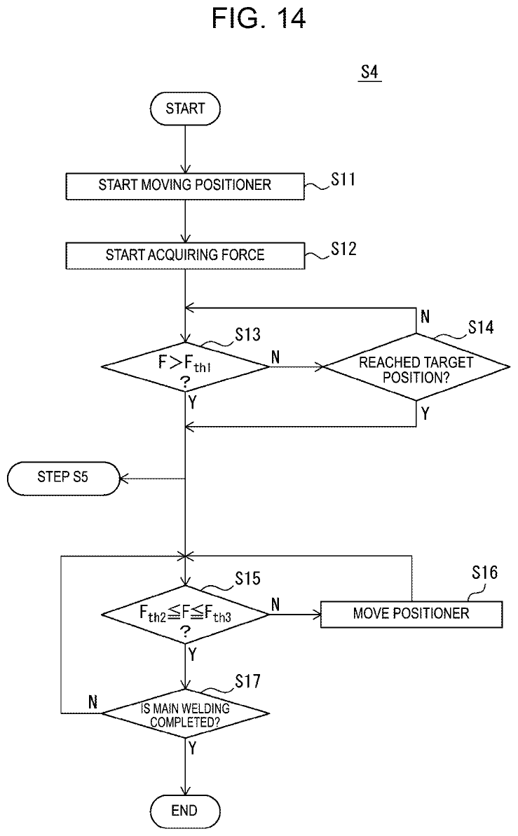

In the flowchart illustrated in FIG. 12, the processor 102 may continue the force control on the driver 40 in step S4 until step S7 is ended. Such a flowchart is illustrated in FIG. 14. FIG. 14 illustrates another example of step S4. In the flowchart illustrated in FIG. 14, after the processor 102 determines to take YES in step S13 or S14, the processor 102 starts step S5 described above and executes steps S15 to S17 in parallel with steps S5 to S7.

Specifically, in step S15, the processor 102 determines whether or not the most recently acquired force F falls within a predetermined permissible range [Fₜₕ₂, Fₜₕ₃]. Of the permissible range [Fₜₕ₂, Fₜₕ₃], a lower limit value Fₜₕ₂ is defined in advance with respect to the force F, as a value smaller than the above-described threshold value Fₜₕ₁.

An upper limit value Fₜₕ₃ is defined in advance with respect to the force F, as a value larger than the lower limit value Fₜₕ₂. The upper limit value Fₜₕ₃ may be set to the same value as the above-described threshold value Fₜₕ₁ or may be set to a value slightly smaller (or larger) than the threshold value Fₜₕ₁. The processor 102 determines to take YES if Fₜₕ₂≤F≤Fₜₕ₃, and the process proceeds to step S17. On the other hand, if F<Fₜₕ₂ or F>Fₜₕ₃, the processor 102 determines to take NO, and the process proceeds to step S16.

In step S16, the processor 102 moves the positioner 34. For example, when the processor 102 determines to take NO because of F<Fₜₕ₂ in the most recent step S15, the processor 102 moves the positioner 34 rightward by a predetermined distance x₄. On the other hand, when the processor 102 determines to take NO because of F>Fₜₕ₃ in the most recent step S15, the processor 102 moves the positioner 34 leftward by a predetermined distance x₅.

Here, during steps S5 to S7 in FIG. 12, the positioners 34 and 36 may be pulled in a direction approaching each other due to deflection or the like of the workpiece W1, W2, or W3. In this case, the force F reduces and there arises a possibility that the force for clamping the workpieces W1, W2, and W3 by the positioners 34 and 36 reduces improperly. In contrast, during steps S5 to S7, the positioners 34 and 36 may be pushed in a direction separating from each other due to expansion or the like of the workpiece W1, W2, or W3. In this case, the force F increases and there arises a possibility that the drivers 40 and 42 are overloaded.

In the present embodiment, in step S16, the processor 102 moves the positioner 34 in a direction in which the force F can fall within the permissible range [Fₜₕ₂, Fₜₕ₃]. With this configuration, even when deformation or the like of the workpiece W1, W2, or W3 occurs during steps S5 to S7, the position of the positioner 34 can be appropriately adjusted in accordance with the deformation. This makes it possible to hinder an improper reduction in force for clamping the workpieces W1, W2, and W3 by the positioners 34 and 36 and to hinder the drivers 40 and 42 from being overloaded, during steps S5 to S7.

In step S17, the processor 102 determines whether or not the main welding processing in step S7 is completed. If the processor 102 determines to take YES, the processor 102 ends step S4 (i.e., force control) and stops the positioner 34. On the other hand, if the processor 102 determines to take NO, the process returns to step S15. In this way, the processor 102 repeatedly executes steps S15 to S17 until the processor 102 determines to take NO in step S17 and performs force control on the driver 40 so that the force F falls within the predetermined permissible range [Fₜₕ₂, Fₜₕ₃] during steps S5 to S7.

Distances x₄ and x₅ used in step S16 may be the same value or may be different values. The distance x₄ (or x₅) may be set to change in accordance with a difference ΔF between the force F acquired most recently and the lower limit value Fₜₕ₂ (or the upper limit value Fₜₕ₃). For example, the distance x₄ (or x₅) may be set to be larger as the difference ΔF becomes larger.

In step S11 described above, the processor 102 may generate the position command CP_{1_2} for positioning the positioner 34 at the target position P_{1_2} and may perform position control on the driver 40 in accordance with the position command CP_{1_2}. In this case, the processor 102 performs the force control and the position control in parallel in step S4.

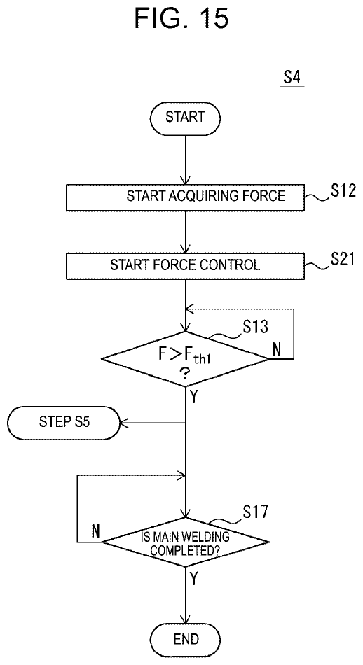

There are various modified examples of step S4. FIG. 15 illustrates still another example of step S4. In a flowchart illustrated in FIG. 15, processing similar to that of the flowchart in FIG. 14 is denoted by the identical step number, and redundant description thereof will be omitted. The processor 102 executes step S12 to start acquiring the force F after starting the flowchart in FIG. 15.

In step S21, the processor 102 starts the force control. Specifically, the processor 102 generates a force command CF. The force command CF is a command for defining a target value of the force F (e.g., 5 [kN]). In step S21, the processor 102 generates the force command CF, calculates a difference between the force F acquired most recently from the force sensor 114 and the force command CF, and generates a command C40 (speed command and torque command) for the driver based on the difference.

The driver 40 moves the positioner 34 by controlling the driver 40 in accordance with the command C40. At the start of step S21, the positioner 34 is arranged at the initial position P_{1_0}, and the force F acquired from the force sensor 114 is substantially 0. Accordingly, after the start of step S21, the driver 40 moves the positioner 34 rightward in accordance with the force command CF (command C40). In this way, the processor 102 performs force control on the driver 40 so that the force F matches the force command CF in accordance with the force F acquired from the force sensor 114.

Then, the processor 102 executes step S13. When the processor 102 determines to take YES, the processor 102 starts step S5, and the process proceeds to step S17. On the other hand, when the processor 102 determines to take NO, the processor 102 iterates step S13. The threshold value Fag used in step S13 at this time can be set to a value smaller than the force command CF (e.g., 5 kN). In this way, during steps S5 to S7 in FIG. 12, the processor 102 performs the force control on the driver 40 so that the force F matches the force command CF. This makes it possible to effectively manage and optimize the force F applied from the positioner 34 to the workpiece W1 during steps S5 to S7.

The force sensor 114 may be arranged to detect the force F applied to the positioner 36 via the workpieces W1, W2, and W3 by the positioner 34 moved rightward by the driver 40. In this case, the force sensor 114 may include a torque sensor that detects the load torque of the driver 42, a current sensor that acquires the feedback current F₂ of the driver 42, or a strain gauge provided in the chuck mechanism 70 (chuck 76) or the workpiece W3.

Then, the processor 102 may execute step S4 described above based on the force F applied to the positioner 36. The processor 102 may execute step S15 in FIG. 14 instead of step S13 illustrated in FIG. 15 and may start step S5 and make the process proceed to step S17 when the processor 102 determines to take YES in step S15.

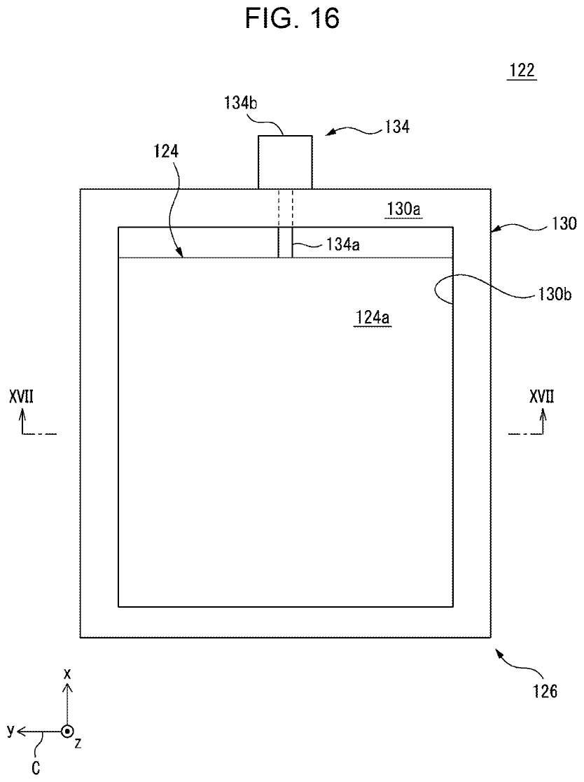

As a modified example of the above-described slide mechanism 84, various forms are conceivable. Hereinafter, a workpiece support mechanism 122 according to another embodiment will be described with reference to FIG. 16 to FIG. 18. The workpiece support mechanism 122 includes, in addition to the above-described support column 78 and elevator 80 (FIG. 5), a workpiece platform 124 and a slide mechanism 126.

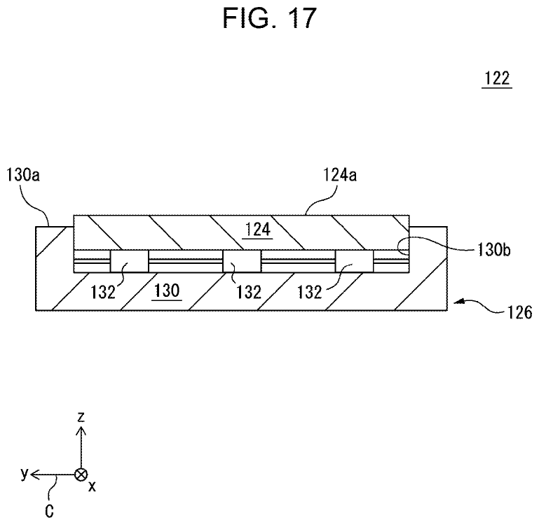

In the present embodiment, the workpiece platform 124 is a flat plate member having a substantially rectangular shape, and the workpiece W1 is placed on a top face 124a thereof. The slide mechanism 126 is fixed on the support table 86 of the elevator 80 and supports the workpiece platform 124 slidably in the x-axis direction of the coordinate system C. Specifically, the slide mechanism 126 includes a main body 130, a plurality of rollers 132 (FIG. 17), and a biasing portion 134.

The main body 130 has a top face 130a and a slide groove 130b recessed downward from the top face 130a. The slide groove 130b has a substantially rectangular outer shape and has a length in the x-axis direction of the coordinate system C longer than that of the workpiece platform 124. The workpiece platform 124 is accommodated inside the slide groove 130b to be slidable in the x-axis direction of the coordinate system C.

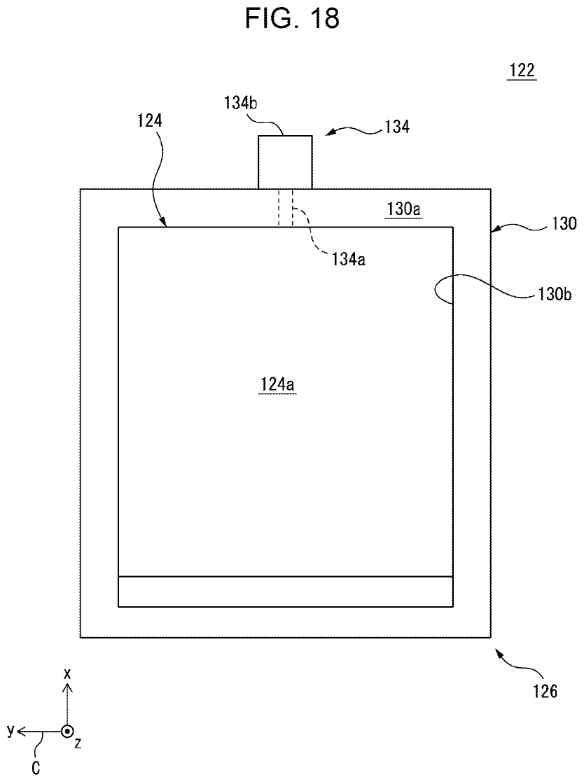

Each of the rollers 132 is provided inside the slide groove 130b so as to be rotatable about an axis substantially parallel to the y-axis of the coordinate system C, and the workpiece platform 124 is installed on the rollers 132. With the rotation of the rollers 132, the workpiece platform 124 can slide inside the slide groove 130b between an initial position illustrated in FIG. 16 and a slide position illustrated in FIG. 18.

The workpiece platform 124, when it is arranged at the initial position, is engaged with a left wall face defining the slide groove 130b, whereby the leftward movement of the workpiece platform 124 is restricted. In other words, the slide mechanism 126 allows the workpiece platform 124 to slide rightward from the initial position, while restricts the workpiece platform 124 from sliding leftward from the initial position.

The biasing portion 134, when the workpiece platform 124 slides rightward from the initial position to the slide position, biases the workpiece platform 124 leftward. Specifically, the biasing portion 134 is a pneumatic or hydraulic cylinder, a servo motor, or the like and includes a drive shaft 134a provided in the main body 130 to be movable backward and forward in the x-axis direction of the coordinate system C, and a power section 134b that moves the drive shaft 134a backward and forward.

A tip of the drive shaft 134a is mechanically coupled to the workpiece platform 124. The power section 134b moves the drive shaft 134a forward in response to a command from the control device 16, thereby biasing leftward the workpiece platform 124 arranged at the slide position toward the initial position. Thus, the biasing portion 134 is a device that can be automatically controlled by the control device 16.

When the flowchart illustrated in FIG. 12 is carried out in the industrial machine 10 to which the workpiece support mechanism 122 is applied, the processor 102 moves the positioner 34 leftward to push the workpiece W1 with the workpiece W2 in order to clamp the workpiece W1 with the workpieces W2 and W3 in step S4. In response to this operation, the workpiece platform 124 slides rightward from the initial position (FIG. 16) to the slide position (FIG. 18) by the action of the slide mechanism 126, and as a result, the workpiece W1 is clamped between the workpieces W2 and W3.

Thereafter, after step S6 (or when step S6 is started and the workpiece platform 124 is separated from the workpiece W1), the processor 102 operates the biasing portion 134 to slide the workpiece platform 124 leftward from the slide position to the initial position. As a result, the workpiece platform 124 returns to the initial position.

According to the present embodiment, the workpiece platform 124 can be biased to the initial position after the workpiece platform 124 is separated from the workpiece W1, which makes it possible to hinder a scratch or the like from being generated on the workpiece W1 due to the workpiece platform 124 relatively sliding on the workpiece W1 during the execution of step S6.

The above-described slide mechanism 84 may further include a lock mechanism that locks the workpiece platform 82 when the workpiece platform 82 slides rightward and reaches a predetermined slide position. In this case, the lock mechanism may include an engagement pin that can move backward and forward between an engagement position at which the engagement pin engages with the workpiece platform 82 at the slide position to restrict the leftward slide of the workpiece platform 82 and a disengagement position at which the engagement pin is disengaged from the workpiece platform 82 and include a power section (a cylinder, a servo motor, or the like) that automatically moves the engagement pin backward and forward in response to a command from the control device 16.

In this case, when the workpiece platform 82 slides from the initial position to the slide position in step S4, the processor 102 operates the power section of the lock mechanism to engage the engagement pin with the workpiece platform 82, thereby locking the workpiece platform 82 to the slide position. On the other hand, after step S6 (or when step S6 is started and the workpiece platform 82 is separated from the workpiece W1), the processor 102 releases the lock by the lock mechanism through operating the power section of the lock mechanism to disengage the engagement pin from the workpiece platform 82.

As a result, the workpiece platform 82 slides leftward by the action of the biasing portion 100 and automatically returns to the initial position. This configuration makes it possible to hinder a scratch or the like from being generated on the workpiece W1 due to the workpiece platform 82 relatively sliding on the workpiece W1 during the execution of step S6.

In the above-described embodiment, the driver 42 may be omitted and the positioner 36 may be fixed at a predetermined position (e.g., the above-described target position P_{2_1}). The processor 102 may perform the force control illustrated in FIG. 13, 14, or 15 based on the acquired force F with respect to the driver 42 instead of performing the position control on the driver 42 in step S2 described above. In this case, the force sensor 114 may be arranged to detect the force F applied to the positioner 36 as described above.

In step S4 described above, the processor 102 may generate the position command CP_{1_2} for positioning the positioner 34 at the target position P_{1_2} and may perform position control on the driver 40 in accordance with the position command CP_{1_2}, without performing force control. In the above-described embodiment, the case of the industrial machine 10 performing the welding operation is described. However, the industrial machine 10 may be configured to perform any type of operation, such as cutting with a tool, laser machining with a laser beam, painting or the like. In this case, the end effector 28 includes a tool, a laser machining head, or a paint applicator. The rotary table 62 may be omitted.

The slide mechanism 84 may be configured to allow the workpiece platform 82 to slide leftward from the initial position. In other words, the slide mechanism 84 supports the workpiece platform 82 slidably from the initial position to the left and right in this case. The biasing portion 100 or 134 may be omitted from, respectively, the slide mechanism 84 or 126. In this case, the operator may manually slide the workpiece platform 82 or 124 to the left and right.

Although the present disclosure is described above referring to the embodiments, the above-described embodiments are not limited to the invention according to the claims.

### REFERENCE SIGNS LIST

10 Industrial machine
12 Robot
14 Working device
16 Control device
28 End effector
34, 36 Positioner
42, 44, 46, 48 Driver
62, 74 Rotary table
84, 126 Slide mechanism
100, 134 Biasing portion
110, 112 Position sensor
114 Force sensor
116 Position controller
118 Force acquisition section
120 Force controller

1. An industrial machine comprising:
a workpiece platform on which a first workpiece is placed;
a pair of positioners configured to clamp the first workpiece placed on the workpiece platform, one of the pair of positioners being movable toward and away from the other of the pair of positioners; and
a slide mechanism configured to support the workpiece platform slidably in an approaching direction in which the one of the pair of positioners approaches the other of the pair of positioners.

2. The industrial machine of claim 1, wherein the slide mechanism allows the workpiece platform to slide in the approaching direction from a predetermined initial position, while restricts the workpiece platform from sliding in a direction opposite to the approaching direction from the initial position.

3. The industrial machine of claim 1, wherein the slide mechanism includes a biasing portion configured to bias the workpiece platform in a direction opposite to the approaching direction when the workpiece platform slides in the approaching direction.

4. The industrial machine of claim 1, further comprising:
a first driver configured to move the one of the pair of positioners;
a force acquisition section configured to acquire force by which the one of the pair of positioners, which is moved in the approaching direction by the first driver, pushes the first workpiece; and
a force controller configured to control an operation in which the first driver moves the one of the pair of positioners in the approaching direction so as to cause the pair of positioners to clamp the first workpiece, based on the force acquired by the force acquisition section.

5. The industrial machine of claim 4, wherein the other of the pair of positioners is movable toward and away from the one of the pair of positioners,
wherein the industrial machine further comprises:
a second driver configured to move the other of the pair of positioners; and
a position controller configured to control the second driver to position the other of the pair of positioners at a predetermined target position, before the force controller causes the pair of positioners to clamp the first workpiece,
wherein the force controller controls the first driver to move the one of the pair of positioners in the approaching direction when the position controller positions the other of the pair of positioners at the target position.

6. The industrial machine of claim 5, wherein the one of the pair of positioners grasps a second workpiece, and the other of the pair of positioners grasps a third workpiece,
wherein the target position is defined as a position where the third workpiece grasped by the other of the pair of positioners is separate away from the first workpiece,
wherein the slide mechanism slides the workpiece platform in the approaching direction in response to the force controller moving the one of the pair of positioners in the approaching direction to push the first workpiece by the second workpiece, and
wherein the pair of positioners clamp the first workpiece between the second workpiece grasped by the one of the pair of positioners and the third workpiece grasped by the other of the pair of positioners positioned at the target position.

7. The industrial machine of claim 6, further comprising a welding torch configured to weld the first workpiece and the second workpiece to each other and weld the first workpiece and the third workpiece to each other, while the pair of positioners clamps the first workpiece.

8. The industrial machine of claim 1, wherein each of the pair of positioners includes a rotary table configured to rotate the clamped first workpiece about an axis parallel to the approaching direction.
